(19) United States
(12) Patent Application Publication
(10) Pub. No.: US 2009/0048827 A1
(43) Pub. Date: Feb. 19, 2009

(54) METHOD AND SYSTEM FOR AUDIO FRAME ESTIMATION

(76) Inventor: Manoj Kumar, Jagadeesh Nagar (IN)

Correspondence Address: MCANDREWS HELD & MALLOY, LTD, 500 WEST MADISON STREET, SUITE 3400, CHICAGO, IL, 60661, US

(21) Appl. No.: 11/840,754

(22) Filed: Aug. 17, 2007

(51) Int. Cl. G10L 19/14

(52) U.S. Cl. 704/205; 704/E19.001

(57) ABSTRACT

The disclosed systems and methods relate to estimating an audio frame. Aspects of the present invention may improve audio quality at the client side when a section of voice data is corrupted or delayed during transmission. The present invention may be suitable for decoding in, for example, circuit switched and packet switched digital voice applications.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Audio transmission bandwidth may be optimized by digitally encoding voice. However, the quality of the decoded voice may not always match that of the analog predecessor. Unnatural audio artifacts may occur and substantial degrade the quality of a phone conversation.

Wireless communication devices rely of digital encoding and decoding techniques. Wireless service providers may also be limited by the available transmission bandwidth. Therefore, a tradeoff exists between audio quality and achievable service capacity.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for estimating audio as shown in and/or described in connection with at least one of the figures, as set forth more completely in the claims. Advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for audio frame correction in accordance with a representative embodiment of the present invention; and

FIG. 2 is an illustration of an exemplary system for audio frame correction in accordance with a representative embodiment of the present invention.

### DETAILED DESCRIPTION OF THE INVENTION

Aspects of the present invention relate to estimating audio frames that may have been corrupted or delayed during transmission. Although the following description may refer to particular network schemes and media standards, many other schemes and standards may also use these systems and methods.

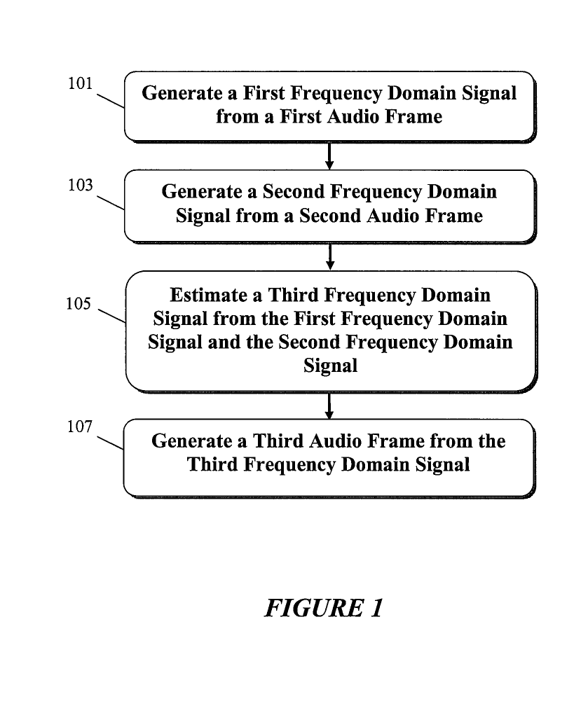

FIG. 1 is a flowchart illustrating an exemplary method for audio frame correction in accordance with a representative embodiment of the present invention.

When an audio frame is corrupted or missing, the audio frame may be estimated from reliable audio frames. For example, a first audio frame and a second audio frame may be received at the proper time and without error. If a third audio frame is unavailable, the third audio frame may be estimated from the first and the second audio frames. The third audio frame may be located before, after, or between the first and second audio frames.

A first frequency domain signal is generated from the first audio frame at 101; and a second frequency domain signal is generated from the second audio frame at 103. The frequency domain signals may be generated by using a Fast Fourier transform (FFT). An FFT may be applied on the input PCM (pulse code modulated) samples of an audio frame. The FFT length may be based on the encoding frame size. For example, an encoding frame size of 1152 samples may correspond to an FFT length of 1024, since 1024 is the nearest power of 2. Any FFT algorithm (e.g., Radix-2, Radix-4, Split-Radix or Mix-Radix) may be used for finding the magnitudes and phases in the frequency domain. If a particular FFT technique generates the complex values as a+jb, the magnitudes may be derived as sqrt (a²+b²), and the phases may be derived as tan⁻¹(b/a).

A third frequency domain signal is estimated from the first frequency domain signal and the second frequency domain signal at 105 in such a way that magnitude and phase are maintained in continuation for all the frequencies in the three frequency domain signals. Interpolation (or extrapolation) of the first and second frequency domain signals may be accomplished, for example, by using a linear, finite order Lagrange polynomial or a finite order sinc filter. The interpolation technique may be based on the available processing bandwidth and/or the level of approximation required during interpolation. Based on the encoding frame size, the magnitudes and phases for all the frequencies in the adjacent first or second frequency domain signal may be used as initial magnitudes phases for all the frequencies in the third frequency domain signal.

A third audio frame is generated from the third frequency domain signal at 107. Since the phases and magnitudes for all the frequencies in the third frame are estimated in continuation, audible artifacts may be reduced. When frames are lost during live transmission, the quality of decoded audio may be improved.

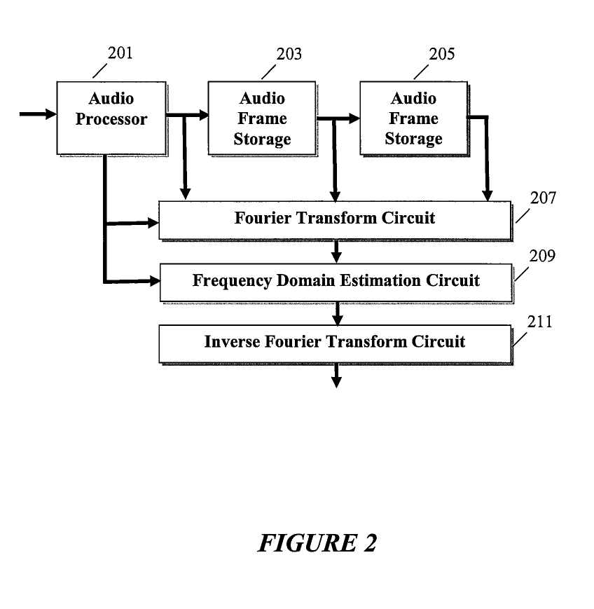

FIG. 2 is an illustration of an exemplary system for audio frame correction in accordance with a representative embodiment of the present invention. Audio frames are processed by the audio processor, 201. Processed audio frames may be stored in buffers, 203 and 205. If the audio processor, 201, determines that at least one of the processed audio frames is either corrupt or missing, the Fourier Transform Circuit, 207, may generate the corresponding frequency domain signals of the good audio frames. In the frequency domain estimation circuit, 209, the frequency domain representation of the audio frame that was corrupt may be estimated from the frequency domain representations of the good audio frames. The inverse Fourier transform circuit, 211, will receive the frequency domain estimation. The corrupt audio frame may then be replaced by the output of the inverse Fourier transform circuit, 211.

The system in FIG. 2 may be suitable for decoding in circuit switched and packet switched digital voice applications. For example, in a Voice over IP application, the audio quality may be improved at the client side by this system if a section of voice data had been corrupted or delayed during transmission.

The present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for audio frame estimation, wherein the system comprises:
an audio processor for receiving and decoding a plurality audio frames, wherein the audio processor determines the quality of audio frames;
a transform circuit for generating a first frequency domain signal according to a first audio frame, wherein the first audio frame has a suitable quality;
a frequency domain estimation circuit for estimating a second frequency domain signal according to the first frequency domain signal; and
an inverse transform circuit for generating a replacement frame that replaces a second audio frame, wherein the second audio frame has an unsuitable quality.

2. The system of claim 1, wherein the first audio frame is error-free when decoded.

3. The system of claim 1, wherein the second audio frame comprises errors when decoded.

4. The system of claim 1, wherein the second audio frame is not received at a proper time.

5. The system of claim 1, wherein the second audio frame is after the first audio frame.

6. The system of claim 1, wherein the second audio frame is before the first audio frame.

7. The system of claim 1, wherein
the transform circuit generates a third frequency domain signal according to a third audio frame, wherein the third audio frame has a suitable quality, and wherein
the frequency domain estimation circuit estimates the second frequency domain signal according to the third frequency domain signal.

8. The system of claim 7, wherein the second audio frame is after the first audio frame and after the third audio frame.

9. The system of claim 7, wherein the second audio frame is before the first audio frame and the third audio frame.

10. The system of claim 7, wherein the second audio frame is between the first audio frame and the third audio frame.

11. The system of claim 7, wherein the system is an element of a wireless baseband processor.

12. A method for audio frame estimation, wherein the method comprises:
generating a first frequency domain signal according to a first audio frame, wherein the first audio frame has a suitable quality;
estimating a second frequency domain signal according to the first frequency domain signal; and
generating a replacement frame to replace a second audio frame, wherein the second audio frame has an unsuitable quality.

13. The method of claim 12, wherein the first audio frame is error-free when decoded.

14. The method of claim 12, wherein the second audio frame comprises errors when decoded.

15. The method of claim 12, wherein the second audio frame is not received at a proper time.

16. The method of claim 12, wherein the second audio frame is after the first audio frame.

17. The method of claim 12, wherein the second audio frame is before the first audio frame.

18. The method of claim 12, wherein the method further comprises:
generating a third frequency domain signal according to a third audio frame, wherein the third audio frame has a suitable quality; and
estimating the second frequency domain signal according to the third frequency domain signal.

19. The method of claim 12, wherein the second audio frame is after the first audio frame and after the third audio frame.

20. The method of claim 12, wherein the second audio frame is before the first audio frame and before the third audio frame.

21. The method of claim 12, wherein the second audio frame is between the first audio frame and the third audio frame.

22. The method of claim 12, wherein the method is performed in a wireless baseband processor.
